(19) United States
(12) Patent Application Publication
(10) Pub. No.: US 2014/0157106 A1
(43) Pub. Date: Jun. 5, 2014

(54) DYNAMIC BUILDING OF A WEB PAGE FROM WIDGETS AND RESOURCES SPECIFIED IN A UNIFORM RESOURCE LOCATOR (URL)

(71) Applicant: INTERNATIONAL BUSINESS MACHINES CORPORATION, Armonk, NY (US)

(72) Inventors: Randal L. Bertram, Raleigh, NC (US); Edward N. Fink, Raleigh, NC (US); Aaron D. Sahlin, Rochester, MN (US); Andrew J. Streit, Rochester, MN (US)

(73) Assignee: INTERNATIONAL BUSINESS MACHINES CORPORATION, Armonk, NY (US)

(21) Appl. No.: 13/691,629

(22) Filed: Nov. 30, 2012

(51) Int. Cl. G06F 17/22

(52) U.S. Cl. CPC G06F 17/2247
USPC 715/234

(57) ABSTRACT

In one embodiment, a system for providing a web page includes logic adapted to access a uniform resource locator (URL), wherein the URL comprises hash parameters specifying one or more widgets, logic adapted to create a web page by loading each widget specified in the hash parameters of the URL, and logic adapted to output the web page. In another embodiment, a computer program product for designing a web page includes a computer readable storage medium having program code embodied therewith, the program code readable/executable by a computer to: access a URL, wherein the URL comprises hash parameters specifying one or more widgets, create a web page by loading each widget specified in the hash parameters of the URL, and output the web page. Other systems, methods, and computer program products for providing a web page using widgets specified in a URL are described according to even more embodiments.

### BACKGROUND

The present invention relates to construction of web pages, and more particularly, to building web pages from widgets and resources specified in a uniform resource locator (URL).

For systems management web applications, many different web pages are composed from a variety of available and reusable widgets. A widget may be any code, application, or JavaScript class that creates an object, such as via implementation of a constructor, which takes or receives parameters and a pointer to a source document object model (DOM) node, such as a srcNodeRef. Any of these widgets may be composites of one or more simpler widgets. In other words, each major area of a display may be rendered based on a “super-widget,” which may include a plurality of simpler widgets and which may be reused to build many different web pages for display of information from a broad range of resources. For example, a “tree selector” widget may include a tree, a title, buttons, and possibly other sub-widgets of even simpler construction.

The web pages are composed from the widgets in a flexible way, so that new pages may be easily defined during prototyping and development. Moreover, new pages may be created in the field after installation of a system, after the product has shipped, so that a user's needs that may not be acknowledged or readily known during building of the system are capable of being addressed on site. Many systems management applications have a rich ecosystem of resources, along with different types of resources, and specified collections of resources. A large number of different pages are possible given these resources, using different permutations of the widgets and types/groups of resources. It is desirable to be able to create new web pages from these widgets and resources/groups without re-releasing new content. Furthermore, it would be beneficial for users of a systems management application to be able to add new widgets of their own design to web pages that they are capable of creating themselves.

One conventional method of meeting these goals is referred to as a “mashup.” Web pages are created with configuration files, and often through the aid of visual builders. Another, similar solution is provided by Java Portlet Specification V1.0, or Java Specification Request (JSR) 168 portlets, which are used in some systems management solutions. One drawback of these solutions is that each requires that artifacts, such as configuration files, be delivered to a user of the systems management application, or created by the user in on site at the end environment. Furthermore, mashups are typically overly complex and may present more problems through their use than is necessary to address a user's desires, particularly for newer user interfaces (UIs), which strive for simplicity and fast execution/delivery of content. In fact, some newer UIs enforce a simple, consistent page layout, which would be problematic for mashups that are created over a period of time.

Therefore, a simpler, more direct solution is desirable. In addition, it would be beneficial to not include any new software components (e.g., a mashup engine) in order to deliver the solution, so as to avoid new dependencies.

### BRIEF SUMMARY

In one embodiment, a system for providing a web page includes logic adapted to access a uniform resource locator (URL), wherein the URL comprises hash parameters specifying one or more widgets, logic adapted to create a web page by loading each widget specified in the hash parameters of the URL, and logic adapted to output the web page.

In another embodiment, a computer program product for designing a web page includes a computer readable storage medium having program code embodied therewith, the program code readable/executable by a computer to: access a URL, wherein the URL comprises hash parameters specifying one or more widgets, create a web page by loading each widget specified in the hash parameters of the URL, and output the web page.

According to another embodiment, a method for providing a web page includes accessing a URL, wherein the URL comprises hash parameters specifying one or more widgets, creating a web page by loading each widget specified in the hash parameters of the URL, and outputting the web page.

In yet another embodiment, a computer program product includes a computer readable storage medium having program code embodied therewith, the program code readable/executable by a computer to: provide a URL adapted to provide a web page, the URL comprising: one or more widgets specified in hash parameters of the URL, the one or more widgets being capable of being loaded on the computer to create the web page, and at least one reference corresponding to a first widget, the at least one reference

Other aspects and embodiments of the present invention will become apparent from the following detailed description, which, when taken in conjunction with the drawings, illustrates by way of example the principles of the invention.

### BRIEF DESCRIPTION OF THE SEVERAL VIEWS OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for building a web page from widgets and resources, according to one embodiment.

FIG. 4 shows an example of a hardware map page, according to one embodiment.

FIG. 5 shows an example of a details selector page, according to one embodiment.

FIG. 6 shows an example of an active alerts page, according to one embodiment.

FIG. 7 shows an example of a page having a non-standard widget, according to one embodiment.

FIG. 8 shows an example of a page having groups sorted in the selector, according to one embodiment.

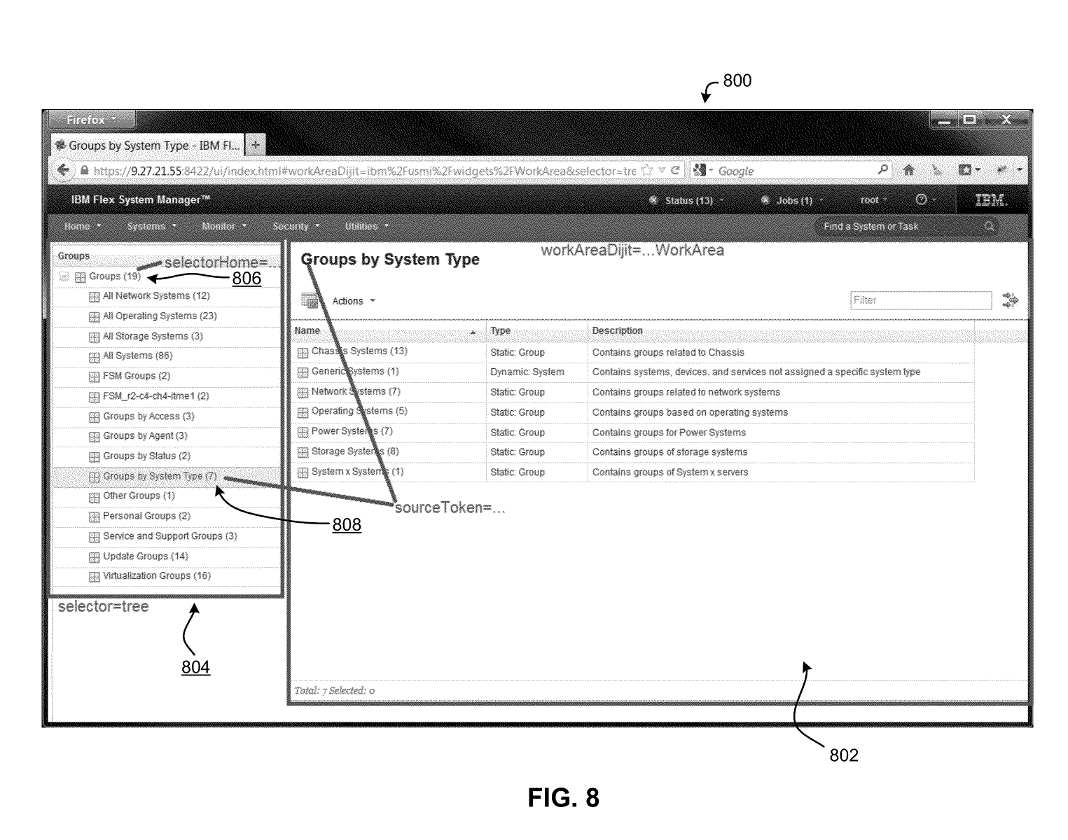

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for composing a web page from widgets and resources that are specified in a uniform resource locator (URL). This allows new web pages to be easily added during prototyping and development of a systems management application, and also in the field after the systems management application is released and utilized by an end user. New web pages may combine existing widgets and new widgets, with the widgets communicating using standard pre-defined events. All web pages may be bookmarked and accessible in a browser's history list, since they are completely defined by the URL.

In one general embodiment, a system for providing a web page includes logic adapted to access a URL, wherein the URL comprises hash parameters specifying one or more widgets, logic adapted to create a web page by loading each widget specified in the hash parameters of the URL, and logic adapted to output the web page.

In another general embodiment, a computer program product for designing a web page includes a computer readable storage medium having program code embodied therewith, the program code readable/executable by a computer to: access a URL, wherein the URL comprises hash parameters specifying one or more widgets, create a web page by loading each widget specified in the hash parameters of the URL, and output the web page.

According to another general embodiment, a method for providing a web page includes accessing a URL, wherein the URL comprises hash parameters specifying one or more widgets, creating a web page by loading each widget specified in the hash parameters of the URL, and outputting the web page.

In yet another general embodiment, a computer program product includes a computer readable storage medium having program code embodied therewith, the program code readable/executable by a computer to: provide a URL adapted to provide a web page, the URL comprising: one or more widgets specified in hash parameters of the URL, the one or more widgets being capable of being loaded on the computer to create the web page, and at least one reference corresponding to a first widget, the at least one reference including at least a location of a resource or a collection of resources that is used by the first widget in creating the web page.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as “logic,” “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device, such as an electrical connection having one or more wires, an optical fiber, etc.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. Any type of processor may be used, such as a central processing unit (CPU), an integrated circuit (IC), an application specific integrated circuit (ASIC), a field programmable gate array (FPGA), a microprocessor, etc.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

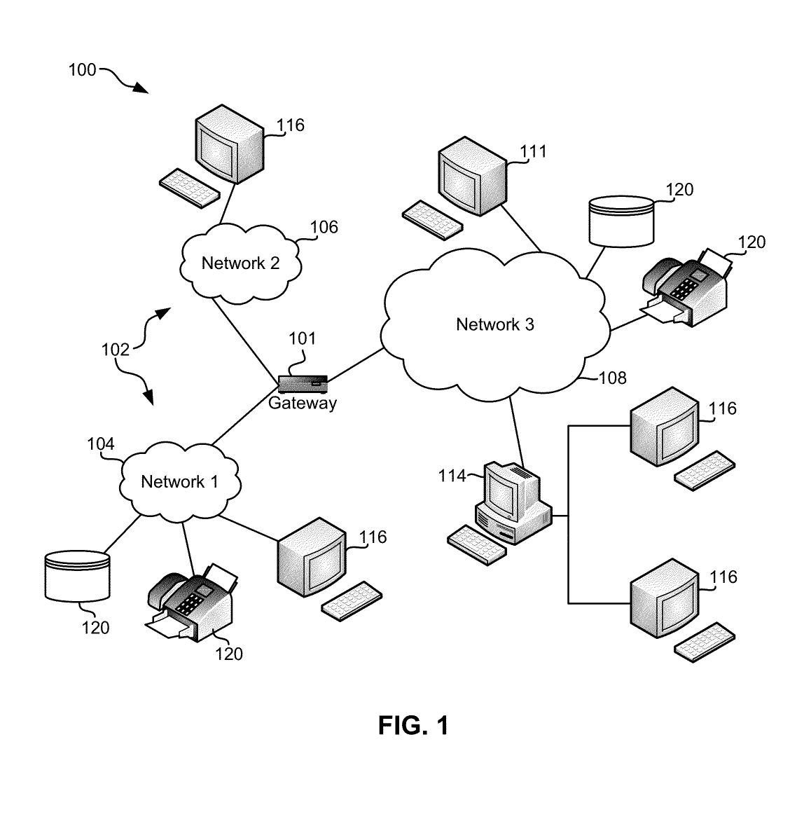

FIG. 1 illustrates a network architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

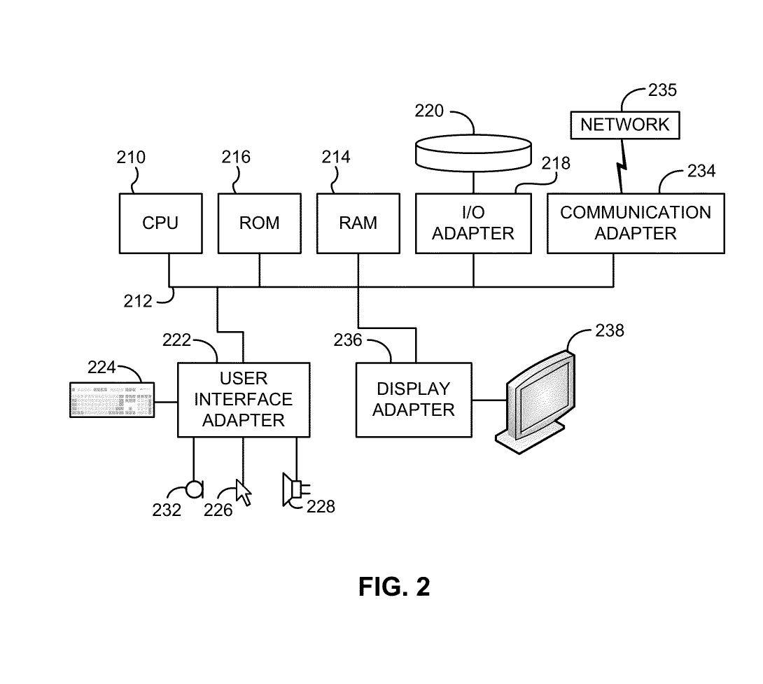

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

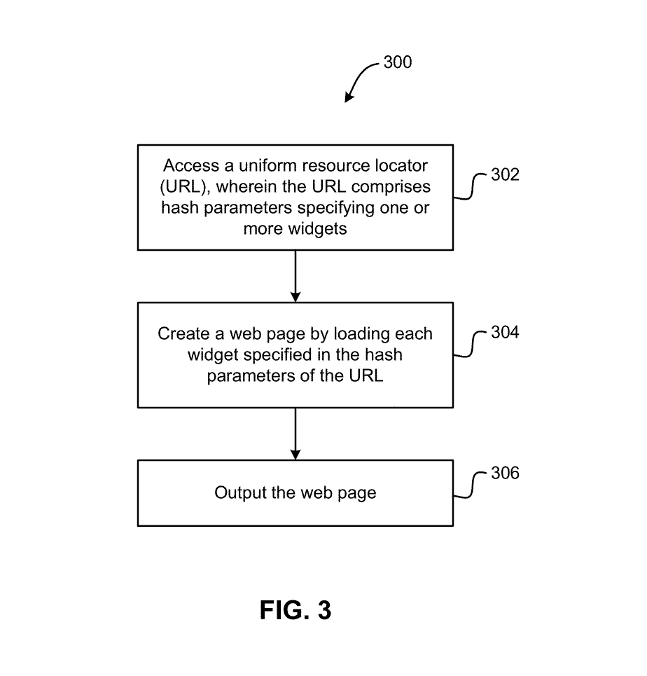

Now referring to FIG. 3, a method 300 for providing a web page is shown according to one embodiment. The method 300 may be performed in accordance with the present invention in any of the environments depicted in FIGS. 1-2, among others, in various embodiments. Of course, more or less operations than those specifically described in FIG. 3 may be included in method 300, as would be understood by one of skill in the art upon reading the present descriptions.

Each of the steps of the method 300 may be performed by any suitable component of the operating environment. For example, in various non-limiting embodiments, the method 300 may be partially or entirely performed by an enterprise systems manager, a network controller, a computing system, a server, a processor (such as a CPU, an ASIC, a FPGA, etc.) which may be embedded in and/or operate within a system, etc.

As shown in FIG. 3, method 300 may initiate with operation 302, where a URL is accessed. The URL comprises hash parameters specifying one or more widgets.

Each of the widgets may be loaded to a specific area of the web page, which may be specified or particular to the widget being called. Furthermore, the size, look, and feel of the widget may be partially based on the web page to which it is constructed. For example, a selector widget may preferentially load to the left side of a web page by default, but a user setting or a reference in the URL may specify that the selector widget be loaded to the right side, bottom, or top of the page, as desired by the user.

In a further embodiment, the URL may also include one or more references corresponding to each widget. Each of the references may include, at a very minimum, a location of a resource or a location of a collection of resources. Other information may be included as well, such as name, type of resource, keyword for resource, or any other pertinent data. Any resource may be indicated by the URL, including by not limited to, a server, a processor, a memory or storage device, a connection, a relationship between devices in a network, a network interface, etc.

For the collection of resources, any separation of resources may be used to differentiate the resources into collections, as described herein and/or known in the art. For example, resources may be aggregated into a collection based on type, date stamp, usage, author, size, location, name, or any other discernible parameter known to be associated with resources.

In one approach, keywords may be used to load existing widgets or to specify new widgets to be loaded, the new widgets being either discovered locally by a computing system, or received and loaded with the loading of the URL. These keywords may be typically associated with standard widgets, such as dijits, or may be specified for customized widgets accessible to the computing system.

In operation 304, a web page is created by loading each widget specified in the hash parameters of the URL. In this way, a web page may be constructed from widgets specified in the URL. The widgets may be common, typical widgets of a variety known in the art, such as Dojo widgets “dijits,” or specialized widgets created for particular tasks, either particular to the web page being built or more uniformly used for a particular user, computing system, category of use, etc.

In one embodiment, resources may be allocated dynamically based on which resource(s) or collection(s) of resources are specified for each widget loaded to create the web page. Furthermore, as the web page, and particularly the widgets that form the web page, are interacted with and/or as conditions within the system, network, and/or resources change over time while a web page is loaded. In an attempt to more efficiently manage resource allocation and increase performance of the web page interaction, the resource(s) or collection(s) of resources allocated for any particular widget may dynamically change as well to match current conditions within the system and/or network.

According to another embodiment, resources unknown to the computing system when the web page is created may become available, and any widget which is allocated similar resources (such as a resource of the same type, having the same location, having the same characteristic, etc.) may be allocated the newly available resources as well, which may be added dynamically to a collection of resources or as another resource sorted by a particular widget.

In another embodiment, the web page may have context awareness, possibly through intelligent widget loading and/or management. For example, each widget may be loaded and/or managed after loading based on context of the computing system, widget, web page, etc., such as processor speed, processor capacity, display size, display capability, security rights to access sensitive information, number of widgets currently displayed, size of currently displayed widgets, color schemes, button size, etc. In this way, a web page and the widgets thereof may dynamically adjust for changing conditions of the system and/or network, possibly without the need for reloading or refreshing the URL.

According to preferred embodiments, the use of the URL to build the web page makes it possible to create the web page without the use of a visual builder, which results in what is referred to as “a mashup.” However, certain aspects of the URL-built web page may make use of combining and/or modifying hashtags to create and/or modify widgets. Although a mashup uses two or more services to create a new service (and/or functionality), the URL may utilize combinations of hashtags to modify and/or create new widgets.

In operation 306, the web page is output in any fashion known in the art. In one embodiment, outputting includes displaying the web page on a display, projector, or some other display device known in the art. In another embodiment, outputting includes publishing the web page to the internet, thereby allowing access to the web page by multiple parties, either remote or local. In yet another embodiment, outputting may include printing, storing, sharing, referencing, or otherwise making known the existence of the web page to one or more parties.

According to one embodiment, the web page may be a user interface (UI), and the method 300 may further include receiving input from a user via the UI. In this way, in an example of a systems management application, such as IBM's Flex System Manager but not so limited, a user may receive indication, status of, progress of, or some other description of one or more resources or collections of resources via one or more widgets, and then provide input via one of the widgets that is received by the computing system, which may then be acted upon by one of the widgets, thereby providing for a dynamic web page interaction.

According to one embodiment, the web page may be output via a browser application, via s systems management application, or via some other suitable application local to or remote from the computing system which loaded the URL.

According to one embodiment, a system for providing a web page may include logic adapted to access a URL, wherein the URL comprises hash parameters specifying one or more widgets; logic adapted to create a web page by loading each widget specified in the hash parameters of the URL; and logic adapted to output the web page.

Any of the embodiments described above with respect to method 300 may also be incorporated into the system as logic, as would be understood by one of skill in the art.

In another embodiment, a computer program product for designing a web page comprises a computer readable storage medium having program code embodied therewith, the program code readable/executable by a computer to: access a URL, wherein the URL comprises hash parameters specifying one or more widgets; create a web page by loading each widget specified in the hash parameters of the URL; and output the web page.

Any other embodiments and/or approaches described in regard to method 300 may be included as computer program code in the computer program product, according to various implementations.

According to various embodiments, presented by way of example only, and not meant to be limiting on the invention in any way, IBM's Next Generation User Interface (NGUI) product for use with systems management applications, and specifically IBM's Flex System Manager, may be used in conjunction with approaches presented herein.

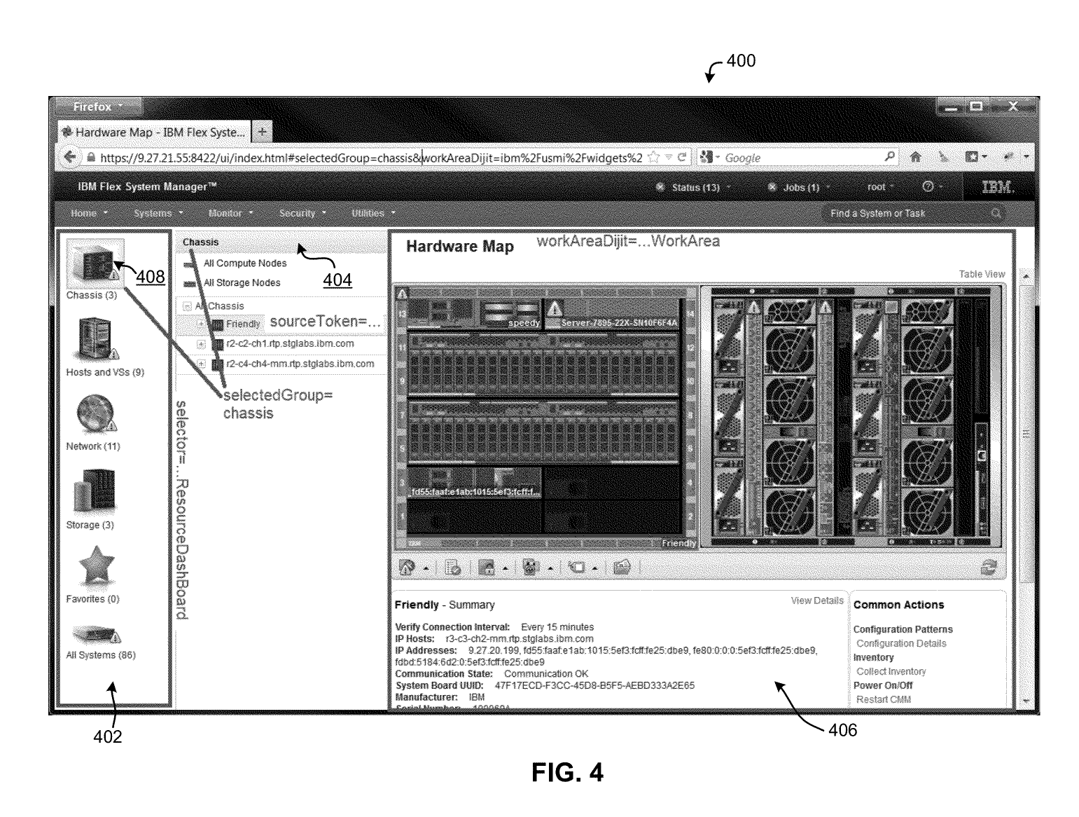

For example, a page showing a Hardware Map 400 in IBM's Flex System Manager is shown in FIG. 4, according to one approach. This page may be used as a starting page for the Flex Explorer in IBM's xSeries firmware, in some approaches. Different portions of the URL which was used to build the web page 400 include:
selector= . . . ResourceDashBoard: The vertical bar of icons on the left side of the display is the ResourceDashBoard 402 (also referred to as the “dashbar”). The selector may be any widget, such as a Dojo widget (often referred to as a “dijit”), and its job is to display and receive input selection of selection events.
selectedGroup=chassis: The selection in the dashbar is the “Chassis.” When a dashbar icon is selected from the dashbar 402, it sends out an event which is consumed by the “Tree Selector” 404 to its right, which has the title “Chassis” in FIG. 4. Accordingly, when the Chassis dashbar icon 408 is selected in the dashbar 402, Chassis becomes the title of the Tree Selector 404 in this column area.
sourceToken= . . . : In this example, the selection in the Tree Selector 404 is “Friendly.” Selecting Friendly in the Tree Selector 404 sends out a selection event which is consumed by the Work Area 406 to the right of the Tree Selector 404. Note that Friendly is the name of one chassis in the Hardware Map (it is a subunit of the chassis).
workAreaDijit= . . . WorkArea: The Work Area 406 is the large area to the right of the Tree Selector 404, which currently holds the Hardware Map. The content of the Work Area 406 may be a dijit or some other widget. The workAreaDijit parameter tells the system which dijit to load, in one approach. In another approach, another parameter may be used to determine which widget to load. The dijit called “WorkArea” is a general-purpose dijit that listens for events, such as the selection event to “load Friendly” from the Tree Selector 404, and loads the appropriate sub-dijits that correspond to the selected dijit.

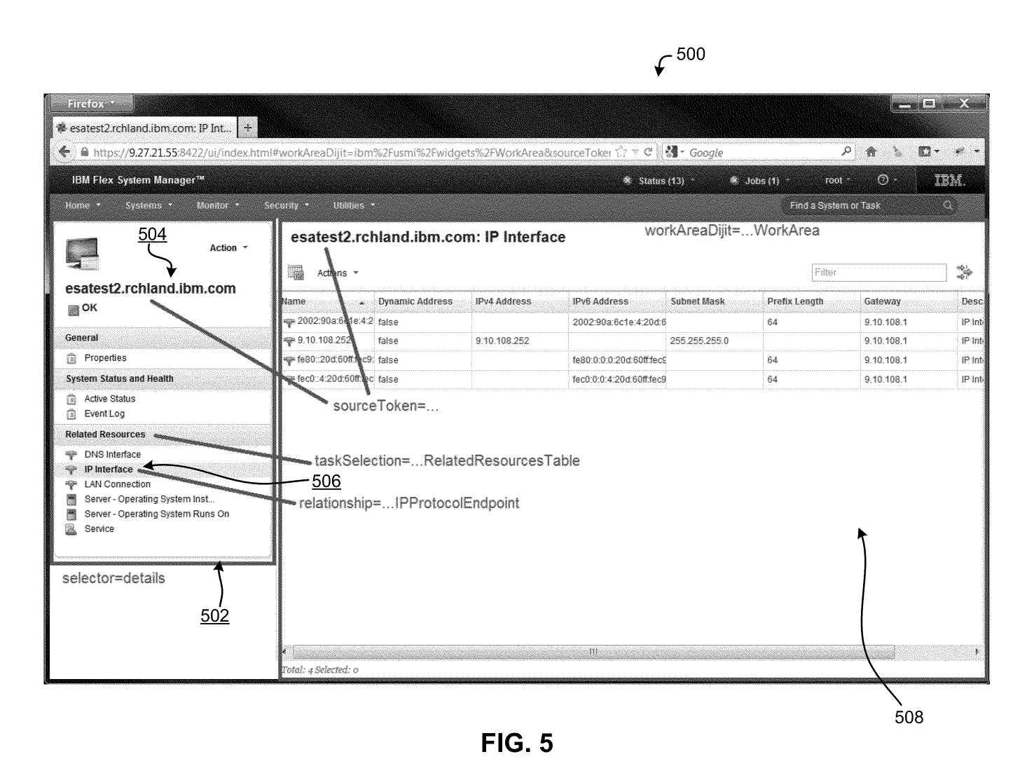

In another example, a Details Selector 500 in IBM's Flex System Manager is shown in FIG. 5, according to one approach. Different portions of the URL which was used to build the web page 500 include:
sourceToken= . . . : A resource 504 that the Details page is focused on is designated here in the selector 502, and in this example, it is esatest2.rchland.ibm.com. (id=9819).
selector=details: The selector 502 may be a dijit, as in the previous example. But in this example, it is a special keyword (“details”) that is used for the common Details Selector 502, which may be used on multiple different web pages.
taskSelection= . . . RelatedResourcesTable, relationship= . . . IPProtocolEndpoint: This sub-selection 506 allows for indication of what is selected in the Details Selector 502. Selecting “IP Interface” sends out an event, which is consumed by
workAreaDijit= . . . WorkArea: As shown in FIG. 4, in FIG. 5, this Work Area 508 is a dijit that listens for selection events, such as the sub-selection 506 of “IP Interface” in the Details Selector 502, and loads appropriate sub-dijits upon hearing specific selection events.

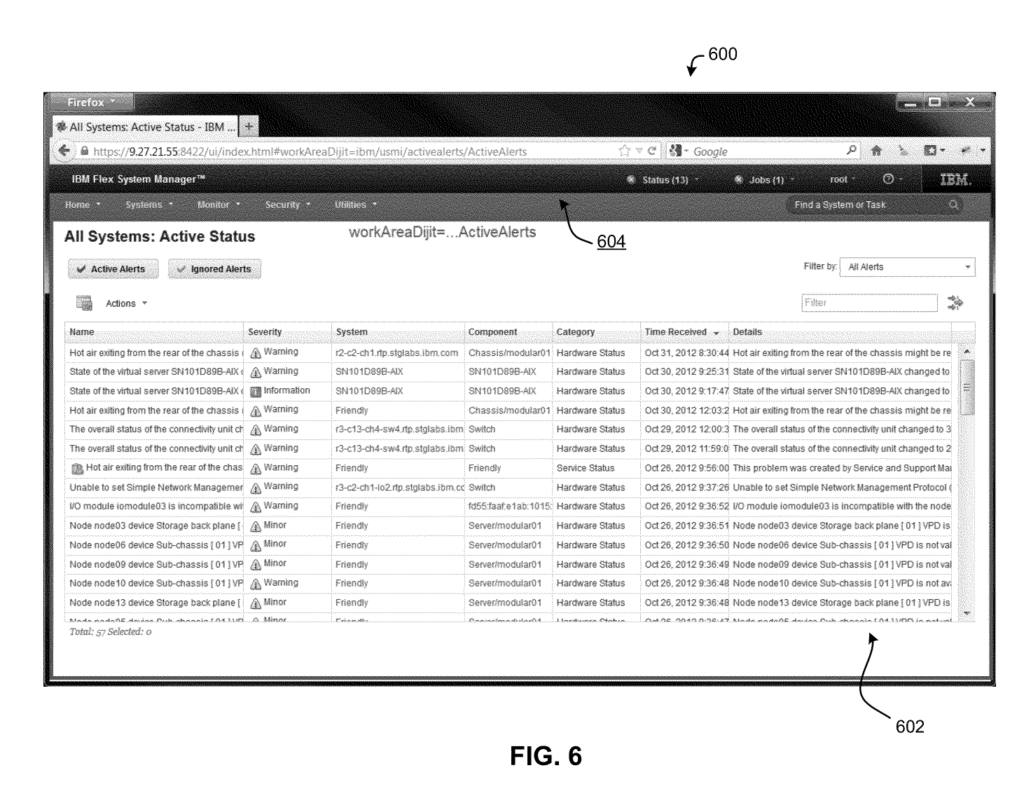

According to another example, an Active Alerts page 600 in IBM's Flex System Manager is shown in FIG. 6, according to one approach. Different portions of the URL which was used to build the web page 600 include:
workAreaDijit= . . . ActiveAlerts: The ActiveAlerts dijit 602 fills up the entire display area, because there is no selector in the URL. Since there is no sourceToken, this screen applies to All Systems. This example shows how the workAreaDijit may be any Dojo widget, not just the generic WorkArea dijit shown in FIGS. 4-5.

Referring again to FIG. 6, note that the workAreaDijit parameter lets any dijit take over the entire screen, just below and underneath the header 604. Any dijit may be inserted into the GUI 600, without necessarily even participating in the FSM/Director ecosystem of resources and collections.

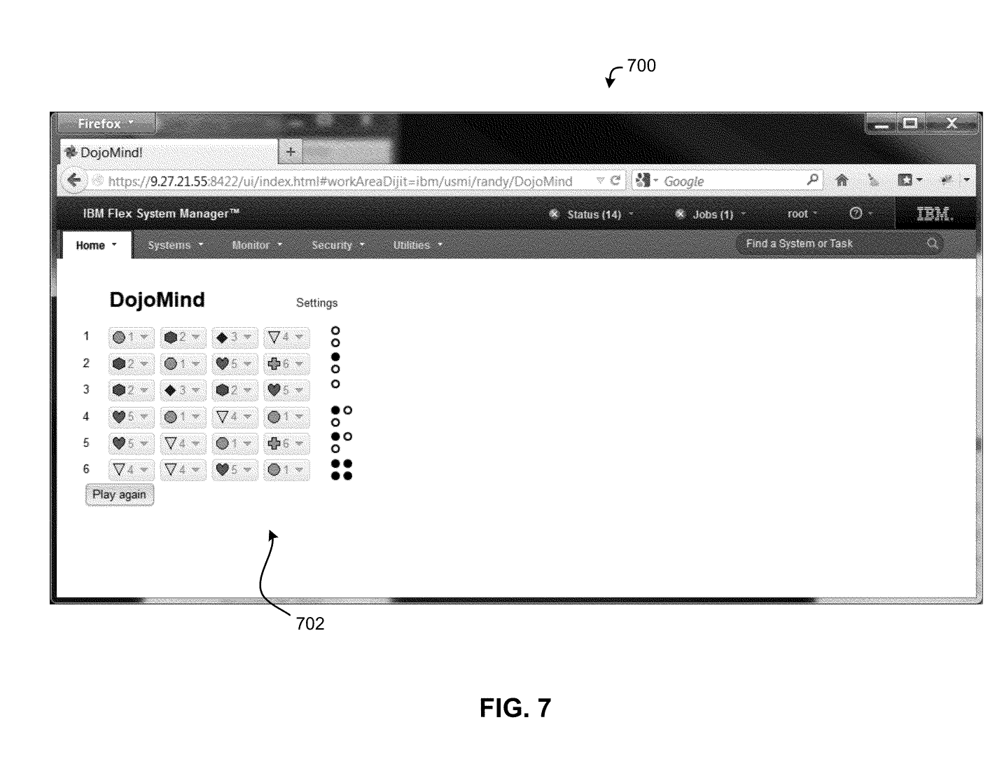

In the next example, referring to FIG. 7, a page is shown with a non-standard widget in the Work Area. In this example, the widget is called DojoMind 702 and is a Mastermind inspired game. In order to insert the DojoMind dijit 702 into the GUI, access to the FSM appliance's file system is required, so only a highly privileged user would be capable of inserting this dijit into the GUI, in this example. However, in one approach, Cross-Origin Resource Sharing (CORS) may be used to create more options, while maintaining strong security, thereby allowing insertion of such dijits by less privileged users. CORS might enable the entire UI to run from a different server than FSM, and incorporate customer-provided content, according to a further embodiment.

For a more powerful example, imagine FIG. 7 with selector=tree and selectorHome=MY_COMPUTE_NODES. In this example, a Tree Selector would appear on the left of the screen. Replace DojoMind with a dijit that knows how to consume selection events. The dijit could provide new analysis of whichever compute node the user selects. This is not as much fun as DojoMind, but much more useful.

In another example, a web page 800 having Groups shown in the Tree Selector 804 and Groups by System Type displayed in the Work Area 802 is shown. In this example:
selector=tree: The selector may be any dijit, but “tree” (like “details” previously described) is another special keyword that loads the Tree Selector 804. The Tree Selector 804 sends out selection events as the user selects items in the Tree Selector 804.
selectorHome=GROUP ROOT: The Tree Selector 804 shows all groups 806, starting at the root of the group tree. Notice that “Groups” is the title of the selector 804.
sourceToken= . . . : “Groups by System Type” is the selected item 808 in the Tree Selector 804. It causes the Work Area 802 to show “Groups by System Type.”
workAreaDijit= . . . WorkArea: The generic Dojo widget for the Work Area 802, which listens to selection events.

One important point, which applies to the Groups page 800 and to other non-standard web pages is that this view is not provided standard on any product. Instead, it is a page which is available based on the design of the URL which provides the resources and dijits to create the page on a user's system. The user is capable of bookmarking the page provided by the URL so it could be accessed whenever desired.

According to one specific embodiment, the entire UI may be based on a single html page, referred to as “index.html.” The page content may comprise widgets specified in hash parameters of the URL (the portion of the URL that follows the “#”). The URL hash parameters tell which widget to load into each portion of the screen. For example, the “selector” parameter specifies a widget to place on the left of the screen, for selecting a resource. The “workAreaDijit” parameter, in another approach, specifies a widget to place in the main portion of the screen (the work area). All portions of the screen may or may not have a widget positioned therein, e.g., the display of a widget in any particular portion is optional.

In one approach, any number of standard events may be emitted and consumed by the widgets. For example, the selector widget may broadcast a selection event, which may be consumed by another widget in the work area. There are several reusable widgets that may be used for the selector, the work area, and any other portion of the display. In addition, many exploiters may provide their own custom widgets for one or more of these roles. Also, URL hash parameters may set the selections for the selector and other widgets. These may be individual resources or groups of resources. According to this specific embodiment, a web page may be defined by the widgets in the different portions of the screen, plus the resources/groups that are targeted by the widgets, and that is all that is needed to build/define the web page.

According to another embodiment, a computer program product comprises a computer readable storage medium having program code embodied therewith, the program code readable/executable by a computer to: provide a URL adapted to provide a web page, the URL comprising: one or more widgets specified in hash parameters of the URL, the one or more widgets being capable of being loaded on the computer to create the web page; and at least one reference corresponding to a first widget, the at least one reference including at least a location of a resource or a collection of resources that is used by the first widget in creating the web page.

In some further embodiments, at least one of the one or more widgets is a dijit; the resource or the collection of resources may be selected from a group consisting of: a server, a processor, a memory or storage device, a connection, a relationship between devices in a network, and a network interface; the web page may be a UI, and the program code readable/executable by the computer may further cause the computer to receive input from a user via the UI; and/or the web page may be output via a browser application by the computer, and the computer program product may provide for creation of a web page without using a visual builder, resulting in a web page that is not a mashup.

The systems, methods, and computer program products described herein, according to various embodiments, are superior to and much simpler than mashups that are commonly in use, because they are capable of creating a new page via use of a new URL, without any configuration files or builders being used. (Of course, if new widgets are involved, the new widgets are also made available in order to build the web page.) In addition, a mashup would be overkill for newer UIs, which do not need the advanced level of functionality and versatility provided by mashups. Instead, embodiments described herein enforce a simple page layout, ensuring all the UI's displays have a similar layout.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A system for providing a web page, the system comprising:
logic adapted to access a uniform resource locator (URL), wherein the URL comprises hash parameters specifying one or more widgets;
logic adapted to create a web page by loading each widget specified in the hash parameters of the URL; and
logic adapted to output the web page.

2. The system as recited in claim 1, wherein at least one of the widgets is a Dojo widget (a “dijit”).

3. The system as recited in claim 1, wherein the URL further comprises, for at least one of the widgets, one or more references corresponding to the at least one of the widgets, each reference including at least a location of a resource or a collection of resources such that the at least one of the widgets is capable of accessing the resource or the collection of resources.

4. The system as recited in claim 3, wherein the resource or the collection of resources are selected from a group consisting of: a server, a processor, a memory or

5. The system as recited in claim 1, wherein the web page is created without using a visual builder (“a mashup”).

6. The system as recited in claim 1, wherein the web page is a user interface (UI), and the system further comprises logic adapted to receive input from a user via the UI.

7. The system as recited in claim 1, wherein the web page is output via a browser application.

8. A computer program product for designing a web page, the computer program product comprising a computer readable storage medium having program code embodied therewith, the program code readable/executable by a computer to:
access a uniform resource locator (URL), wherein the URL comprises hash parameters specifying one or more widgets;
create a web page by loading each widget specified in the hash parameters of the URL; and
output the web page.

9. The computer program product as recited in claim 8, wherein at least one of the widgets is a Dojo widget (a “dijit”).

10. The computer program product as recited in claim 8, wherein the URL further comprises one or more references corresponding to each widget, each reference including at least a location of a resource or a collection of resources.

11. The computer program product as recited in claim 10, wherein the resource or the collection of resources are selected from a group consisting of: a server, a processor, a memory or storage device, a connection, a relationship between devices in a network, and a network interface.

12. The computer program product as recited in claim 8, wherein the web page is created without using a visual builder (“a mashup”).

13. The computer program product as recited in claim 8, wherein the web page is a user interface (UI), and wherein the program code readable/executable by the computer causes the computer to receive input from a user via the UI.

14. A method for providing a web page, the method comprising:
accessing a uniform resource locator (URL), wherein the URL comprises hash parameters specifying one or more widgets;
creating a web page by loading each widget specified in the hash parameters of the URL; and
outputting the web page.

15. The method as recited in claim 14, wherein at least one of the widgets is a Dojo widget (a “dijit”).

16. The method as recited in claim 14, wherein the URL further comprises one or more references corresponding to each widget, each reference including at least a location of a resource or a collection of resources.

17. The method as recited in claim 16, wherein the resource or the collection of resources are selected from a group consisting of: a server, a processor, a memory or storage device, a connection, a relationship between devices in a network, and a network interface.

18. The method as recited in claim 14, wherein the web page is created without using a visual builder (“a mashup”).

19. The method as recited in claim 14, wherein the web page is a user interface (UI), and the method further comprises receiving input from a user via the UI.

20. The method as recited in claim 14, wherein the web page is output via a browser application.

21. A computer program product, the computer program product comprising a computer readable storage medium having program code embodied therewith, the program code readable/executable by a computer to:
provide a uniform resource locator (URL) adapted to provide a web page, the URL comprising:
one or more widgets specified in hash parameters of the URL, the one or more widgets being capable of being loaded on the computer to create the web page; and
at least one reference corresponding to a first widget, the at least one reference including at least a location of a resource or a collection of resources that is used by the first widget in creating the web page.

22. The computer program product as recited in claim 21, wherein at least one of the one or more widgets is a Dojo widget (a “dijit”).

23. The computer program product as recited in claim 22, wherein the resource or the collection of resources are selected from a group consisting of: a server, a processor, a memory or storage device, a connection, a relationship between devices in a network, and a network interface.

24. The computer program product as recited in claim 21, wherein the web page is a user interface (UI), and the program code readable/executable by the computer further causes the computer to receive input from a user via the UI.

25. The computer program product as recited in claim 21, wherein the web page is output via a browser application by the computer, and wherein the computer program product provides for creation of a web page without using a visual builder (“a mashup”).
